(19) United States
(12) Patent Application Publication
(10) Pub. No.: US 2023/0236480 A1
(43) Pub. Date: Jul. 27, 2023

(54) PHOTOGRAPHY STAND FOR PLACING A CAMERA ENABLED DEVICE

(71) Applicant: Derek Cromer, Fullerton, CA (US)

(72) Inventor: Derek Cromer, Fullerton, CA (US)

(21) Appl. No.: 18/096,652

(22) Filed: Jan. 13, 2023

Related U.S. Application Data
(60) Provisional application No. 63/299,361, filed on Jan. 13, 2022.

(51) Int. Cl. G03B 17/56; F16M 11/22; F16M 11/04; F16M 11/08; F16M 11/42

(52) U.S. Cl. CPC G03B 17/561; F16M 11/08; F16M 11/22; F16M 11/041; F16M 11/42

(57) ABSTRACT

A photography stand configured to aid in a taking of self or group photograph(s). The photography stand is placed in a visited location where photographs are frequently taken with a background of interest. The photography stand comprises a post, a platform, and a holder configured to hold a camera enabled handheld electronic device. The platform has a top surface that is textured and a bottom surface attaches to a top end of the post. The platform is stationary, but in alternative embodiments, the platform spins at the connection with the post. The stand also can be placed into the ground or can include a base on a bottom end of the post which allows the stand to be placed on the ground. The base may include one or more wheels to move the stand.

### CROSS-REFERENCE TO RELATED APPLICATION

This application is a non-provisional application which claims priority to U.S. Provisional Pat. Application No. 63/299,361 filed on Jan. 13, 2022, which is incorporated by reference in its entirety.

### FIELD OF DISCLOSURE

The present invention relates to a device for placing a personal electronic device or another camera enabled device to take pictures alone or with a group.

### BACKGROUND

Many destinations and venues have popular photography sights. Many visitors to these sights generally like to photograph themselves with the sights in the background to commemorate their visit. Most individuals carry a mobile device with a camera feature and some may carry a camera when visiting such places. In fact, selfies have become emblematic of today’s high-tech, modern culture. Smartphones and tablets, which are almost always carried on a person, make it easier than ever to snap photos of oneself or of a group at any place that one sees fitting.

There are some quintessential selfie locations where visitors often like to capture a photo of themselves and/or the group they are with. However, it can be difficult to capture sufficient background, scenery, and/or items of interest in the photograph when attempting to take the photo themselves or even with a selfie stick. Often, the person interested in capturing a photograph at these selfie locations will request the help of a nearby person to take a photo with the background of interest. In some other quintessential selfie locations, a person may request a person working nearby, such as a security guard or a vendor, to stop their work and take a picture of the requestor with the background. However, these are not the most ideal means in many cases.

Thus, there exists a need to provide for a means to take photographs in the selfie locations that is convenient and allows for the camera enabled device to capture a satisfying image of the background of interest.

### SUMMARY

The invention described herein addresses the need for a device to provide an improved means of taking a selfie photograph or video at tourist sights. One or more non-limiting embodiments for a photography stand having a holder which is designed to hold a smartphone or other personal electronic device is described. The holder is configured to hold an electronic device in positions to take photos in a portrait (i.e., upright) or landscape mode (i.e., sideways). The photography stand also comprises of a post which has two ends. A platform, which includes the holder, is configured on a top end of the post. A base is configured on a bottom end of the post. The base is configured to place the photography stand on the ground at a location and maintain the stand in an upright position.

In an embodiment, the platform is rotatable and/or tiltable.

In alternative embodiments, the platform is stationary.

In other embodiments, the photography stand has a wheeled base so that the photography stand may be wheeled to its location and removed as desired by the owner.

In a further embodiment, the photography stand does not include a wheeled base.

Other aspects and advantages of the invention will be apparent from the following description and the appended claims.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is a perspective view of a non-limiting embodiment of a photograph stand.

FIG. 2 is a close-up perspective view of a platform and a holder comprising part of the photography stand.

FIG. 3 is a close-up side view of the platform and the holder from FIG. 2.

FIG. 4 is a bottom view of the platform of the photography stand.

FIG. 5 is a close-up view of a camera enabled electronic device in a landscape mode on the photography stand.

FIG. 6 is a close-up view of a camera enabled electronic device in a portrait mode on the photography stand.

FIG. 7 is a close-up view of a perspective view of the platform with an alternative embodiment of a holder.

### DETAILED DESCRIPTION

In the Summary above and in this Detailed Description, and the claims below, and in the accompanying drawings, reference may be made to particular features of the invention. It may be understood that the disclosure of the invention in this specification includes all possible combinations of such particular features. For example, where a particular feature may be disclosed in the context of a particular aspect or embodiment of the invention, or a particular claim, that feature can also be used, to the extent possible, in combination with and/or in the context of other particular aspects and embodiments of the invention, and in the invention generally.

Where reference may be made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

“Exemplary” may be used herein to mean “serving as an example, instance, or illustration.” Any aspect described in this document as “exemplary” may not necessarily be construed as preferred or advantageous over other aspects.

Throughout the drawings, like reference characters are used to designate like elements. As used herein, the term “coupled” or “coupling” may indicate a connection. The connection may be a direct or an indirect connection between one or more items. Further, the term “set” as used herein may denote one or more of any items, so a “set of items” may indicate the presence of only one item or may indicate more items. Thus, the term “set” may be equivalent to “one or more” as used herein.

The invention described herein addresses the need for a device to provide an improved means of taking a selfie photograph or video at tourist sights. The invention as presently described is a photography stand for assisting users with taking pictures at a particular location. The photography stand is designed with the purpose of being placed (fixedly or wheeled) at specific venues or places of interest where individuals visit and take photographs of themselves (i.e., selfie) with a certain feature in the background. For example, an individual visiting the Dodger Stadium for a game may want to take a selfie with the Gold Glove award. The photography stand would be placed there by a stadium personnel and a holder on the stand would be specifically designed and constructed to allow either a portrait or landscape mode on the electronic device to catch an image of the feature when taking a selfie with the electronic device placed on a platform within the holder.

Referring now to the drawings and the following written description of the present invention, it will be readily understood by those persons skilled in the art that the present invention is susceptible to broad utility and application. Many embodiments and adaptations of the present invention other than those herein described, as well as many variations, modifications, and equivalent arrangements will be apparent from or reasonably suggested by the present invention and the detailed description thereof, without departing from the substance or scope of the present invention. This disclosure is only illustrative and exemplary of the present invention and is made merely for purposes of providing a full and enabling disclosure of the invention.

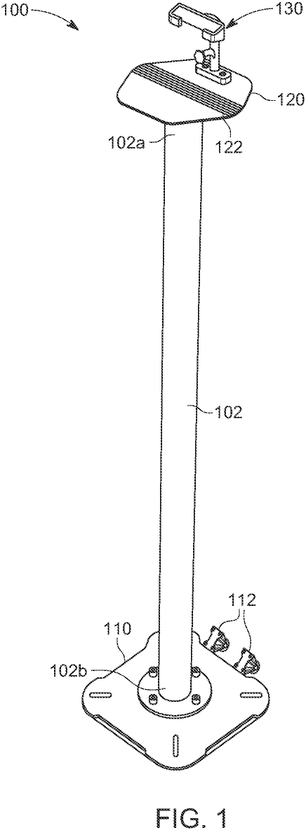

FIG. 1 is an illustration of an example of an improved photography stand, such as photography stand 100. FIG. 1 shows a perspective view of the photography stand 100 constructed in accordance with a non-limiting preferred embodiment of the present invention. The photography stand 100 is adapted for removably placing or installing at a venue or highly visited tourist site where visitors take photographs of themselves or their groups with the background of interest. In accordance with achieving this purpose, one such configuration and geometry is shown in the non-limiting embodiment of the photography stand 100, and it should be understood that other configurations and geometries are also within the realm of this disclosure. Referring to FIG. 1, the photography stand 100 is shown to be comprised of a post 102, a base 110, a platform 120, and a holder 130.

The post 102 is an upright piece used to support the platform 120 and the holder 130. The post 102 has a length which provides a desired height for a camera enabled device to be placed on the platform 120 for taking photographs. The post 102 has a top end 102a and a bottom end 102b, wherein the platform 120 is positioned on the top end 102a and the base 110 is positioned on the bottom end 102b. The post 102 may have a select height between 24 inches to 48 inches. The post 102 may also be custom made and configured at a height requested by a customer for a particular tourist site. Alternatively, the post 102 may be adjustable in height, wherein the desired height may be secured by an individual desiring to take a self-photograph at a place where the photography stand 100 is placed with the particular background. For example, the post 102 may be made up of one or more nesting tubes with a base tube supported on the base 110 and the one or more nesting tubes able to slide within the base to be secured at a certain height.

The post 102 may be hollow or have a solid structure and have a cross sectional shape including, and not limited to, a square cross section, rectangular cross section, a circular cross section, a triangular cross section, a trapezoidal cross section, a polygonal cross section, and an oval cross section. The post 102 may be fabricated from any solid material that can withstand repeated use. The material may include plastics, metal (i.e., aluminum), or a composite.

As seen in FIG. 1, the photography stand 100 also comprises the platform 120. As mentioned above, the platform 120 is positioned on the top end 102a of the post 102. The platform 120 generally has a flat appearance and may have a shape including and not limited to a quadrilateral, a circle, an oval, a triangle, and a polygon. The platform 120 has a top surface and a bottom surface, wherein the top surface is connected to the holder 130 and the bottom surface connects to the post 102. The platform 120 may be configured with dimensions to allow the holder 130 to be positioned on the top surface of the platform 120 and provide adequate support for the holder 130. The platform 120 may also be fashioned from the same material as the post 102, such as plastics and metals.

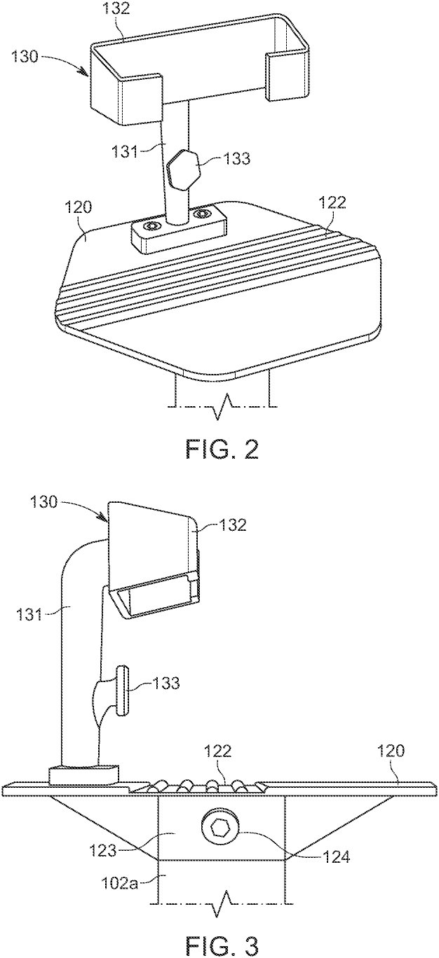

The top surface of the platform 120 includes a textured surface 122 which permits an electronic device to be placed securely on the platform 120 within the holder 130 and prevent slippage of the electronic device. FIGS. 1 to 3 illustrate an example of a design of the textured surface 122, wherein the textured surface 122 is designed as several ridges within which an edge of an electronic device can be rested. It is to be understood that the textured surface 122 can be presented in any design that gives an uneven texture for an electronic device to be placed on. Also, to note in the figures, the textured surface 122 is integrated over a portion of the top surface of the platform 120, which is in the vicinity of the holder 130, and specifically relating to a portion of the top surface where an edge of an electronic device would rest when placed within the holder 130. The textured surface 122 provides a range of adjustment options for an electronic device placed on the platform, such as allowing an electronic device to be placed at varying tilts. In the example shown in FIGS. 1 to 3, the textured surface 122 basically covers a certain amount of a surface area of the top surface. It is to be understood that the textured surface can be integrated over an entire surface of the top surface of the platform 120.

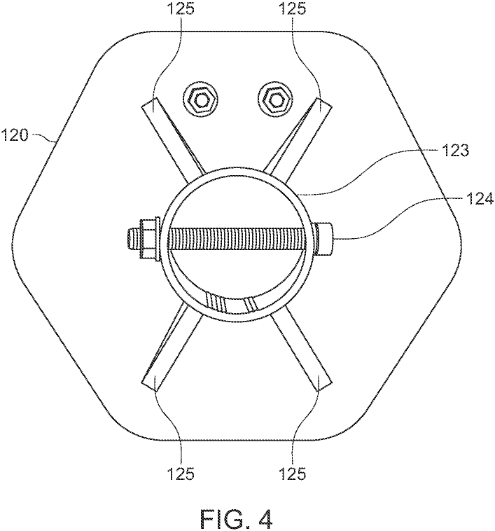

The platform 120 may be placed relatively perpendicular to the post 102, wherein the bottom surface of the platform 120 connects to the post 102. The platform 120 may be connected to the top end 102a of the post 102 with a fastener. In an alternative embodiment, the platform 120 is connected to the top end 102a of the post 102 by a fixture that permits the platform 120 to rotate at the top end 102a. Alternatively, the platform 120 may be integrally connected to the post 102 such as by welding or the post 102 and the platform 120 on the top end 102a may be constructed as one-piece. In the example shown in FIGS. 3 to 5, the platform 120 may be fixed to the top end 102a of the post with a bolt 124 such that the platform 120 is stationary. In this example, a cap 123 is configured centrally on the bottom surface of the platform 120 which fits over the top end 102a of the post 102, and wherein the bolt 124 is then inserted through the cap 123 and the top end 102a of the post 120 to fixedly hold the platform 120. The cap 123 has a shape that is commensurate with the shape of the top end 102a of the post 102 such that the cap fits over the top end 102a. Additionally, the cap 123 may include one or more ribs 125 that are integrated with the platform 120 such as to provide structural strength to the cap 123, especially when the cap 123 is secured to the post 102. As mentioned above, in alternative embodiments, the platform 120 may also be connected to the post 102 in such a manner such that the platform 120 may spin and/or tilt at the connection on the top end 102a. In such an embodiment, the platform 120 may be spun around or tilted to enable an individual desiring to take a photograph to move the platform with the holder 130 on top to adjust to a desired position.

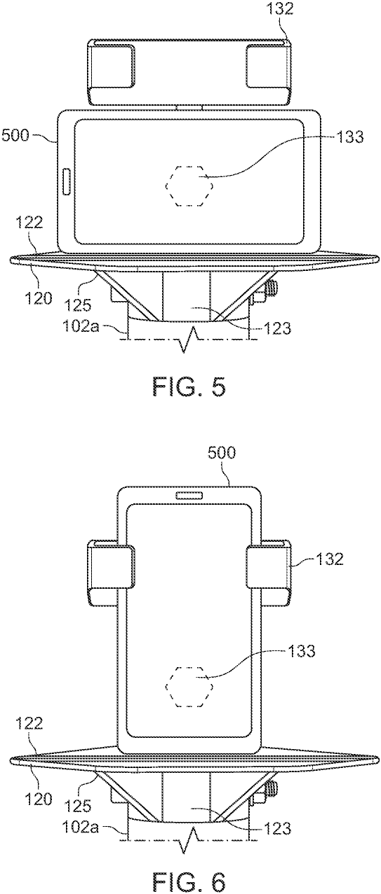

FIGS. 1 to 3 illustrate a non-limiting example of the holder 130, which is positioned on the top surface of the platform 120. As shown, the holder 130 is configured as a separate piece which is secured to the top surface of the platform 120 within the vicinity of the textured surface 122, as discussed above. The holder 130 is configured on the top surface of the platform 120 such that a camera enabled electronic device (e.g., 500 in FIGS. 5 and 6) can be placed within the holder 130 (See, FIG. 6) or against the holder 130 (See, FIG. 5) with an edge of the device 500 resting on the textured surface 122 to be positioned at a desired angle. The holder 130 is shown to have a support 131, a bracket 132, and a prop 133. The support 131 is configured as an upright rod, wherein a top end is configured with the bracket 132 and a bottom end is attached to the platform 120. The prop 133 is configured on the support 131 and positioned between the top end and the bottom end of the support 131. The bracket 132 is designed as having a pair of arms which can enclose or hold a camera enabled electronic device, such as most standard smartphones, in an upright or portrait mode. The prop 133 offers additional support by allowing a back of a camera enabled device to rest against the prop 133. Typically, the prop 133 braces a device, such a smartphone, when the smartphone is positioned in a landscape position wherein the smartphone may not be supported within the bracket 132. The prop 133 may be configured with a flat surface and have any geometric shape. It is also to be understood, that the platform 130 can also accommodate cameras which can be rested on a top surface of the platform 130.

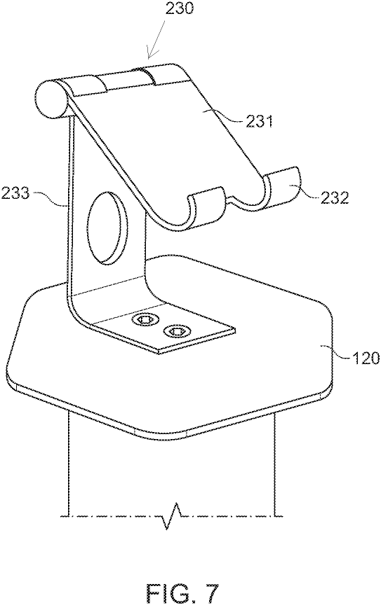

FIG. 7 illustrates an alternative non-limiting embodiment of a holder 230 configured on the top surface of the platform 120. The holder 230 is configured at a particular angle. The holder 230 includes a flat surface 231 with a lip 232 configured on a lower end of the flat surface 231. An upper end of the flat surface 231 is attached to an arm 233, wherein the arm 233 holds the flat surface 231 at a particular angle and secures the holder 230 to the platform 120. The flat surface 231 provides a surface to place a camera enabled device (e.g., mobile phone) and the lip 232 on the lower end holds the camera enabled device in place ensuring that the device stays in place. The holder 230 may be immovably secured to the platform 120 by permanent means such as welding or a fastener.

The holder 230 shown in the non-limiting embodiment in FIG. 7 is fixed at a particular angle. The holder 230 may be fixed at a desired angle during manufacturing of the photography stand 100 and the angle would be determined based on where the photography stand 100 will be placed. Thus, the angle of flat surface 231 of the holder 230 and the height of the post 120 may be custom manufactured based on customer request. It is also to be understood that some standard heights and angles will be also manufactured. A person skilled in the art may also appreciate that the holder 230 may also be adjustable, wherein the angle of the flat surface 231 may be adjustable. In the embodiment shown in FIG. 7, the angle of the flat surface 231 may be adjustable at a point where the flat surface 231 connects to the arm 233. In other words, the flat surface 231 may be pivotally connected to the arm 233 such that the angle may be adjusted and secured in position.

Referring back to FIG. 1, the photography stand 100 also comprises a base 110. The base 110 is positioned on the bottom end 102b of the post 102 and provides an overall support and maintaining the photography stand 100 in a desired location for visitors to take photographs of oneself or their group. The base 110 may generally have a flat appearance and may have a shape including and not limited to a square, a rectangle, a circle, an oval, a triangle, a trapezoid, and a polygon. The base 110 may be placed relatively perpendicular to the post 102 on the bottom end 102b. The base 110 may be integrally connected to the post 102 such as by welding or the post 102 may be fashioned with the base 110 on the bottom end 102b and constructed as one-piece. It is also to be understood that the photography stand 100 may not comprise a base, but instead be provided such as to be permanently installed in the ground at a particular location.

The base 110 may include one or more rollers 112. The one or more rollers 112 may be placed along any edge of the base or positioned on the base such as to provide the function of tilting the photography stand 100 and rolling. Having one or more rollers 112 provides the ease of moving the photography stand 100 to and between locations or moving it to a secure location when not in use (e.g., at night).

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention, according to one or more embodiments described in the present description, may be practiced with modification and alteration within the spirit and scope of the appended claims. Thus, the description is to be regarded as illustrative instead of restrictive of the present invention.

What is claimed is:

1. A photography stand, comprising:
a post, having a top end and a bottom end;
a platform positioned on the top end of the post, wherein a top surface of the platform includes a textured surface;
a base positioned on the bottom end of the post; and
a holder positioned on the top surface of the platform, wherein the holder is configured to hold a camera enabled handheld electronic device.

2. The photography stand of claim 1, wherein the platform is stationarily fixed to the top end of the post.

3. The photography stand of claim 2, wherein a cap is centrally configured on a bottom surface of the platform, wherein the cap has a shape commensurate with a shape of the top end of the post, and wherein the cap is placed over the top end of the post and affixed with a fastener.

4. The photography stand of claim 1, wherein the platform is movably fixed to the top end of the post whereby the platform spins at the top end of the post.

5. The photography stand of claim 1, wherein the textured surface is in a form of one or more ridges.

6. The photography stand of claim 1, wherein the textured surface is integrated on a portion of the top surface of the platform that is proximal to the holder.

7. The photography stand of claim 1, wherein the textured surface is integrated on an entirety of the top surface of the platform.

8. The photography stand of claim 1, wherein the base has one or more wheels configured on an edge of the base.

9. The photography stand of claim 1, wherein the holder includes a support, a bracket, and a prop, wherein:
the support is an upright rod having a top end and a bottom end, wherein the bracket is configured at the top end of the support and wherein the bottom end of the support is connected to the platform; and
the prop is integrated to the support between the top end of the support and the bottom end of the support.

10. The photography stand of claim 1, wherein the holder includes an arm and a flat plate, wherein:
the arm is connected to the platform and to a top end of the flat plate, wherein the flat plate is positioned at an angle to the platform; and
a lip is configured on a lower end of the flat plate.

11. A photography stand, comprising:
a post, having a top end and a bottom end;
a platform positioned on the top end of the post, wherein a top surface of the platform includes a textured surface;
a holder positioned on a top surface of the platform, wherein the holder is configured to hold a camera enabled handheld electronic device; and wherein the bottom end of the post is affixed into a ground surface.

12. The photography stand of claim 11, wherein the platform is stationarily fixed to the top end of the post.

13. The photography stand of claim 12, wherein a cap is centrally configured on a bottom surface of the platform, wherein the cap has a shape commensurate with a shape of the top end of the post, and wherein the cap is placed over the top end of the post and affixed with a fastener.

14. The photography stand of claim 11, wherein the platform is movably fixed to the top end of the post whereby the platform spins at the top end of the post.

15. The photography stand of claim 11, wherein the textured surface is in a form of multiple ridges.

16. The photography stand of claim 11, wherein the textured surface is integrated on a portion of the top surface of the platform that is proximal to the holder.

17. The photography stand of claim 11, wherein the textured surface is integrated on an entirety of the top surface of the platform.

18. The photography stand of claim 11, wherein the holder includes a support, a bracket, and a prop, wherein:
the support is an upright rod having a top end and a bottom end, wherein the bracket is configured at the top end of the support and wherein the bottom end of the support is connected to the platform; and
the prop is integrated to the support between the top end and the bottom end of the support.

19. The photography stand of claim 11, wherein the holder includes an arm and a flat plate, wherein:
the arm is connected to the platform and to a top end of the flat plate, wherein the flat plate is positioned at an angle to the platform; and
a lip is configured on a lower end of the flat plate.
